(19) United States
(12) Patent Application Publication
(10) Pub. No.: US 2025/0293380 A1
(43) Pub. Date: Sep. 18, 2025

(54) ELECTRICITY STORAGE DEVICE

(71) Applicant: TOYOTA JIDOSHA KABUSHIKI KAISHA, Aichi-ken (JP)

(72) Inventors: Kazuhito KATO, Toyota-shi (JP); Yoshiro OBAYASHI, Toyota-shi (JP); Yosuke SHIMURA, Nagakute-shi (JP); Kenta MIYAHARA, Toyohashi-shi (JP); Takuya NOGUCHI, Toyota-shi (JP); Masaya OGURA, Hamamatsu-shi (JP); Yuji KATAYAMA, Okazaki-shi (JP); Ryutaro SUZUKI, Hamamatsu-shi (JP)

(21) Appl. No.: 19/021,172

(22) Filed: Jan. 15, 2025

(30) Foreign Application Priority Data
Mar. 13, 2024 (JP) 2024-039227

(51) Int. Cl. H01M 50/271; H01M 50/209; H01M 50/227; H01M 50/262

(52) U.S. Cl. CPC H01M 50/271; H01M 50/209; H01M 50/227; H01M 50/262

(57) ABSTRACT

An electricity storage device (battery) includes a case. The case includes a hinge part that opens and closes the case. The case houses cell strings. The cell strings include a plurality of electricity storage cells (electricity storage cells in one cell string and electricity storage cells in the other cell string) and connection parts that electrically connect the electricity storage cells to one another (connection parts between the adjacent electricity storage cells in either of the cell strings).

### CROSS-REFERENCE TO RELATED APPLICATION

This application claims priority to Japanese Patent Application No. 2024-039227 filed on Mar. 13, 2024, incorporated herein by reference in its entirety.

### BACKGROUND

### 1. Technical Field

This disclosure relates to an electricity storage device including a plurality of electricity storage cells.

### 2. Description of Related Art

Japanese Unexamined Patent Application Publication (Translation of PCT Application) No. 2023-502457 (JP 2023-502457 A) discloses a rectangular parallelepiped battery (electricity storage device) of which a length L is 400 mm to 2500 mm and a ratio of the length L to a width H (L/H) is 4 to 21.

### SUMMARY

In the electricity storage device described in JP 2023-502457 A, a plurality of electrode body sets (electricity storage cells) connected in series and arrayed in one row is disposed inside a case (housing). Hereinafter, a string of a plurality of electricity storage cells connected in one row will be referred to as a “cell string.”

Manufacturing the above-described electricity storage device requires putting the cell string into the case. For example, it is conceivable to put the cell string into a case main body through an opening provided in the case main body, and then close the opening of the case main body with a lid member and join the case main body and the lid member together. In such an electricity storage device, the case main body and the lid member are separately prepared. This raises a concern such as that a lid member that does not fit the case main body may be prepared or that the case main body and the lid member may be joined together in a misaligned state.

This disclosure has been made to solve the above-described problem, and an object thereof is to facilitate the manufacturing of an electricity storage device including a case that houses a cell string.

According to one form of this disclosure, an electricity storage device shown below is provided.

(First Item) The electricity storage device includes a case. The case includes a hinge part that opens and closes the case. The case houses a cell string. The cell string includes a plurality of electricity storage cells and connection parts that electrically connect the electricity storage cells to one another.

In this configuration, the case includes the hinge part. Thus, after the cell string is put into the case, with the case opened by the hinge part, the case can be closed by the hinge part. In the manufacturing process of the electricity storage device, being able to open and close the case by the hinge part facilitates the manufacturing of the electricity storage device. The hinge part should function at least in the manufacturing process of the electricity storage device, and the case may be fixed in a closed state in the completed product.

(Second Item) In the electricity storage device according to the first item, the case has a rectangular parallelepiped shape. The electricity storage cells are connected to one another in a first direction. The case has a first face, a second face, a third face, and a fourth face that extend in the first direction and a fifth face and a sixth face that are located at both ends in the first direction. The first face and the second face are opposite each other in a second direction that is orthogonal to the first direction. The third face and the fourth face are opposite each other in a third direction that is orthogonal to each of the first direction and the second direction. The second face includes the hinge part. The case includes a first case member and a second case member that are connected to each other through the hinge part. The first face includes a coupling part where the first case member and the second case member are coupled to each other.

The above-described rectangular parallelepiped case extends in the same direction as the cell string (electricity storage cells), which helps appropriately house the cell string. In the manufacturing process of the electricity storage device, the case can be opened and closed by the hinge part. Further, the first case member and the second case member are coupled to each other in the face (first face) on the opposite side from the hinge part (second face). This helps maintain the case in a closed state. In addition, the rectangular parallelepiped case has a simple shape and is therefore easy to manufacture. The above-described configuration eases the manufacturing of the electricity storage device and helps reduce the manufacturing cost.

(Third Item) In the electricity storage device according to the second item, the hinge part is a part where the second face is reduced in plate thickness, and is provided along the first direction.

By thus partially reducing the plate thickness of the second face, the hinge part of a simple configuration can be formed. The above-described configuration facilitates the formation of the hinge part. Moreover, as the hinge part is formed along the first direction, a large opening is likely to be formed when the case is opened by the hinge part. This helps put the cell string into the case.

The plate thickness of the second face may be made smaller than the plate thickness of the first face. Making the plate thickness of the second face smaller promotes deformation of the second face including the hinge part. Making the plate thickness of the first face larger increases the strength of the first face including the coupling part.

(Fourth Item) In the electricity storage device according to the second item or the third item, the coupling part has a snap-fit structure.

In this electricity storage device, the case can be easily maintained in the closed state by mechanical coupling based on the snap-fit structure.

(Fifth Item) In the electricity storage device according to any one of the first item to the fourth item, the case is a case made of resin.

A case made of resin has insulation properties. Thus, this configuration eliminates the need for a component for electrically insulating the case and the components inside the case from each other. As a result, an increase in the number of components can be avoided.

As another form, a vehicle including the electricity storage device according to any one of the first item to the fifth item may be provided.

According to this disclosure, manufacturing of an electricity storage device including a case that houses a cell string is facilitated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view for describing the configuration of an electricity storage device according to an embodiment of this disclosure;

FIG. 2 is a view for describing the function of a hinge part in a manufacturing process of the electricity storage device shown in FIG. 1;

FIG. 3 is a view for describing the configuration of each cell string shown in FIG. 1;

FIG. 4 is a sectional view along line IV-IV in FIG. 1;

FIG. 5 is a view for describing workings and advantages produced by the electricity storage device shown in FIG. 1; and

FIG. 6 is a view showing first to third modified examples of the case shown in FIG. 1.

### DETAILED DESCRIPTION OF EMBODIMENTS

An embodiment of this disclosure will be described in detail with reference to the drawings. The same or equivalent parts in the drawings will be denoted by the same reference sign while description thereof will not be repeated. Of an X axis, a Y axis, and a Z axis that are orthogonal to one another in the drawings to be used below, the X axis indicates a first in-plane direction of a battery (e.g., a length direction); the Y axis indicates a second in-plane direction of the battery (e.g., a width direction); and the Z axis indicates a height direction of the battery. Hereinafter, the directions in which the arrows of the X axis, the Y axis, and the Z axis point will be denoted with a prefix of “+,” and the opposite directions will be denoted with a prefix of “−.”

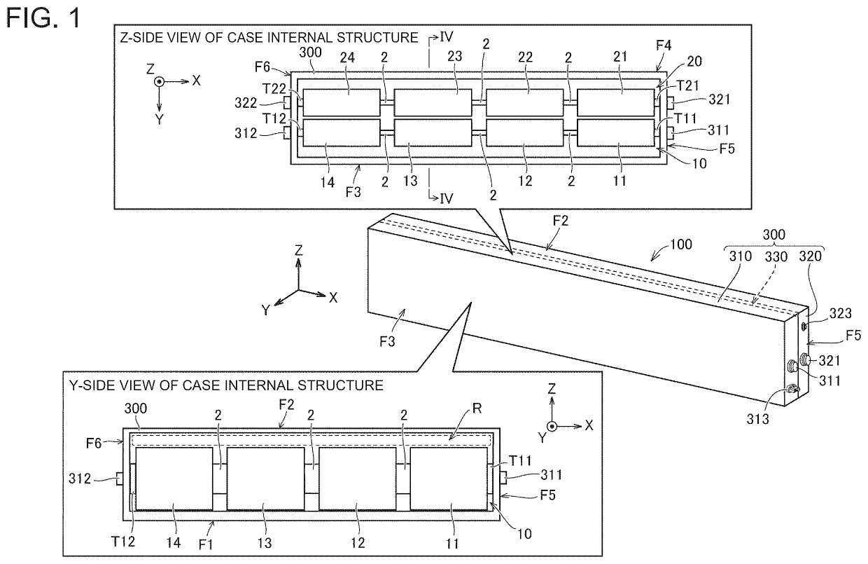

FIG. 1 is a view for describing the configuration of an electricity storage device according to this embodiment. “Z-SIDE VIEW OF CASE INTERNAL STRUCTURE” in FIG. 1 is a view of contents of a case as seen from the +Z side. “Y-SIDE VIEW OF CASE INTERNAL STRUCTURE” in FIG. 1 is a view of the contents of the case as seen from the +Y side.

The electricity storage device according to this embodiment is a battery 100 shown in FIG. 1. The battery 100 is, for example, a secondary battery such as a lithium-ion battery, a nickel-metal hydride battery, or a sodium ion battery. Examples of lithium ion batteries include an LFP battery that adopts lithium iron phosphate as a positive electrode active material, and a ternary battery that adopts nickel-manganese-cobalt (NMC) as a positive electrode active material. The type of the secondary battery may be a liquid-type secondary battery or may be an all-solid-state secondary battery. As will be described in detail later, the battery 100 includes a plurality of electricity storage cells each functioning as a secondary battery. The battery 100 may include only electricity storage cells of the same type (e.g., only LFP batteries) or may include electricity storage cells of different types (e.g., LFP batteries and ternary batteries).

The battery 100 includes a case 300. The case 300 has a rectangular parallelepiped shape with a longitudinal direction oriented in the X direction. The case 300 has a pair of faces F1, F2 opposite each other in the Z direction (first opposite faces), a pair of faces F3, F4 opposite each other in the Y direction (second opposite faces), and faces F5, F6 located at both ends in the X direction (both end faces in the X direction). Each of the faces F1 to F4 extends in the X direction. The area of each of the faces F1, F2 is smaller than the area of each of the faces F3, F4. Each of the faces F1 to F6 corresponds to a plate-shaped part constituting a part of the case 300. The plate thickness of the face F1 is larger than the plate thicknesses of the other faces (faces F2 to F6). The plate thickness of the face F2 is smaller than the plate thicknesses of the other faces (faces F1, F3 to F6). In this embodiment, the X direction, the Z direction, and the Y direction correspond to examples of “first direction,” “second direction,” and “third direction,” respectively, according to this disclosure. The face F1, the face F2, the face F3, the face F4, the face F5, and the face F6 correspond to examples of “first face,” “second face,” “third face,” “fourth face,” “fifth face,” and “sixth face,” respectively, according to this disclosure.

The length (the dimension in the X direction) of the case 300 is larger than the width (the dimension in the Y direction) of the case 300. The length of the case 300 may be 250 mm or larger and 5000 mm or smaller, and is, for example, about 1000 mm. The width of the case 300 may be 10 mm or larger and 1250 mm or smaller, and is, for example, about 50 mm. The ratio of the length of the case 300 to the width of the case 300 may be 4 or higher and 25 or lower. The height (the dimension in the Z direction) of the case 300 may be 10 mm or larger and 1250 mm or smaller, and is, for example, about 100 mm. However, the dimensions (including the plate thickness) of the case 300 are not limited to those mentioned above.

In the face F5, external terminals 311, 321, a connector 313, and a sealing hole 323 are provided. In the face F6, external terminals 312, 322 are provided. The external terminals 311, 312 are joined (e.g., by laser welding) to connection terminals T11, T12, respectively, of a cell string 10. The external terminals 321, 322 are joined (e.g., by laser welding) to connection terminals T21, T22, respectively, of a cell string 20. Each of the external terminals 311, 312, 321, 322 may have an insulation seal structure made of ceramic, for example, around the electrode. In one example, each of the external terminals 311, 322 functions as a negative electrode tab and each of the external terminals 312, 321 functions as a positive electrode tab. A U-shaped connection part may be formed by connecting the external terminal 312 and the external terminal 322 to each other through an electrically conductive member (beam portion). However, without being limited thereto, the polarity can be arbitrarily set. For example, each of the external terminals 311, 321 may be a negative electrode tab and each of the external terminals 312, 322 may be a positive electrode tab. The cell string 10 and the cell string 20 may be electrically connected to each other inside the case 300.

The connector 313 includes, for example, an output terminal through which a detection signal showing a state inside the case 300 (e.g., a temperature of each electricity storage cell) detected by one or more sensors inside the case 300 is output to an outside of the case, and an input terminal through which a control signal is input from the outside of the case to one or more devices inside the case 300. For example, a temperature sensor may be provided for each electricity storage cell inside the case 300. The sealing hole 323 may be a pressure adjustment hole for adjusting a pressure inside the case 300. The sealing hole 323 has, for example, a seal structure composed of a metal cap (outside the case) and a seal member (inside the case). This seal structure can secure airtightness inside the case 300, while allowing gas to be discharged to the outside of the case 300 through the sealing hole 323 when the pressure inside the case 300 exceeds a predetermined level. In the face F6, at least one of a pressure adjustment hole and a gas discharge valve may be further provided.

The case 300 includes case members 310, 320 and a hinge part 330. The external terminals 311, 312 and the connector 313 are provided in the case member 310 (first case member). The external terminals 321, 322 and the sealing hole 323 are provided in the case member 320 (second case member). The hinge part 330 is provided in the face F2. The case member 310 and the case member 320 are connected to each other through the hinge part 330. In this embodiment, resin is adopted as the material composing each of the case member 310, the case member 320, and the hinge part 330. The case 300 is a case made of resin. Compared with a case made of metal, a case made of a resin is easy to deform as well as process. This facilitates the manufacturing of the case 300 having a desired shape and dimensions. The case members 310, 320 and the hinge part 330 may be integrally molded. The materials thereof can be changed as appropriate.

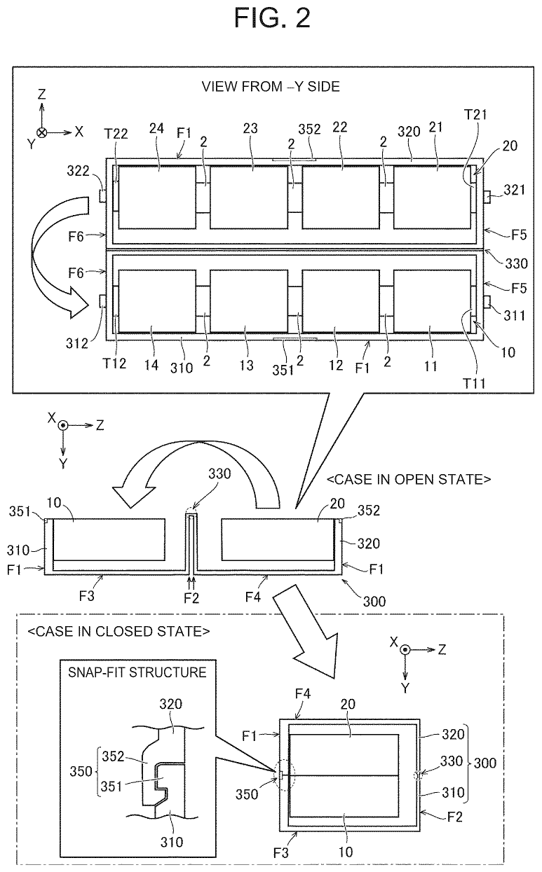

The hinge part 330 is configured to open and close the case 300. In particular, the hinge part 330 is a part where the face F2 is reduced in plate thickness. The plate thickness of the face F2 is smaller than the plate thicknesses of the other faces (faces F1, F3 to F6), and is particularly small around the hinge part 330. By thus partially reducing the plate thickness of the face F2, the hinge part 330 of a simple configuration can be formed. The hinge part 330 is formed along the X direction, linearly in an entire region of the case 300 in the X direction. The hinge part 330 is located between the case member 310 and the case member 320 and formed so as to join the case member 310 and the case member 320 together. The hinge part 330 supports the case members 310 and 320 while allowing opening and closing actions of the case members 310 and 320. Thus, the case members 310 and 320 can turn around the hinge part 330 (an axis in the X direction) as a rotational axis. As one of the case members 310 and 320 turns relative to the other, the case 300 is opened or closed. However, the hinge part 330 should function at least in the manufacturing process of the battery 100, and the case 300 may be fixed in a closed state after completion of the battery 100. FIG. 2 is a view for describing the function of the hinge part 330 in the manufacturing process of the battery 100. In the following, one example of the manufacturing method of the battery 100 will be described using FIG. 2.

First, the case 300 is put in an open state by the hinge part 330. Subsequently, the cell strings 10, 20 are put into the case 300 in the open state. Further, each cell string is joined to the corresponding external terminals.

Specifically, the cell string 10 is disposed inside the case member 310, and the connection terminals T11, T12 of the cell string 10 are joined to the external terminals 311, 312, respectively. The cell string 20 is disposed inside the case member 320, and the connection terminals T21, T22 of the cell string 20 are joined to the external terminals 321, 322, respectively. “VIEW FROM −Y SIDE” in FIG. 2 is a view, as seen from the −Y side, of a state where the cell strings 10, 20 are disposed inside the case 300 in the open state and each cell string is joined to the corresponding external terminals. The cell strings 10, 20 may be bonded to inner faces of the case members 310, 320, respectively. As an adhesive for fixing each cell string to the case 300, for example, an adhesive containing polyethylene terephthalate (PET) or nylon is preferable. The adhesive force of such an adhesive is reduced due to strong acid, which allows for excellent recyclability. The cell strings 10, 20 will be described in detail later.

In the face F1 of the case member 310, a recessed portion 351 (hook receiving portion) is provided. In the face F1 of the case member 320, a projecting portion 352 (hook portion) is provided. The recessed portion 351 and the projecting portion 352 are configured to be able to couple together.

After the cell strings 10 and 20 are put into the case 300, the case 300 is closed by the hinge part 330. In particular, the case 300 is closed such that the recessed portion 351 and the projecting portion 352 are coupled to each other. The recessed portion 351 and the projecting portion 352 have, for example, a snap-fit structure and are mechanically coupled to each other. The closed state of the case 300 is shown at the bottom of FIG. 2. As the projecting portion 352 is fitted into and caught on the recessed portion 351, a part where the case member 310 and the case member 320 are coupled to each other (coupling part 350) is formed (see the enlarged view of the snap-fit structure in FIG. 2). For example, as the recessed portion 351 and the projecting portion 352 fit each other at the coupling part 350, the case member 310 and the case member 320 are coupled to each other. Thus, the battery 100 shown in FIG. 1 is completed. In the battery 100, the face F1 of the case 300 includes the coupling part 350, and the face F2 of the case 300 includes the hinge part 330. The case member 310 constitutes a part of each of the faces F1, F2, F5, F6 of the case 300 on the +Y side from the hinge part 330 (or the coupling part 350) and the face F3. The case member 320 constitutes a part of each of the faces F1, F2, F5, F6 of the case 300 on the −Y side from the hinge part 330 (or the coupling part 350) and the face F4. The case member 310 and the case member 320 may be joined (e.g., welded or bonded) to each other at a gap therebetween in the face F1 to put the case 300 in a hermetic state. An adhesive may be injected through the gap between these case members to fix each cell string to an inner face (face F1) of the case 300. However, it is not essential to put the case 300 in a hermetic state, and the case 300 may be left open. For example, instead of the sealing hole 323, an opening (e.g., a slit) may be formed in the case 300. A heat dissipation hole may be formed at a part of the case 300 corresponding to the electricity storage cells.

As described above, in the manufacturing process of the battery 100, the case can be opened and closed by the hinge part 330, which facilitates the manufacturing of the battery 100. In the following, the cell strings 10, 20 will be described.

Referring to FIG. 1 and FIG. 2, the cell string 10 includes four electricity storage cells 11 to 14 that are arrayed in the X direction and three connection parts 2 that electrically connect the electricity storage cells to one another. The electricity storage cells 11 to 14 are connected in one row in the X direction inside the case 300. The cell string 20 includes four electricity storage cells 21 to 24 that are arrayed in the X direction and three connection parts 2 that electrically connect the electricity storage cells to one another. The electricity storage cells 21 to 24 are connected in one row in the X direction inside the case 300. Thus, the cell string 10 and the cell string 20 are disposed parallel to each other in the X direction. Each of the faces F1 to F4 of the case 300 extends in a coupling direction of the cell strings 10, 20 (X direction). Each of the faces F5, F6 of the case 300 covers end portions in the X direction of the cell strings 10, 20. Each electricity storage cell included in the cell strings 10 and 20 is configured to be able to store electricity.

The cell strings 10 and 20 are disposed such that the positions of each of the electricity storage cells and the corresponding connection parts are aligned. The electricity storage cells 11, 12, 13, 14 included in the cell string 10 are respectively opposite the electricity storage cells 21, 22, 23, 24 included in the cell string 20 in the Y direction. At an end portion on the +X side (electricity storage cell 11) and an end portion on the −X side (electricity storage cell 14) of the cell string 10, the connection terminals T11, T12, respectively, are provided. At an end portion on the +X side (electricity storage cell 21) and an end portion on the −X side (electricity storage cell 24) of the cell string 20, the connection terminals T21, T22, respectively, are provided.

In this embodiment, the cell string 10 and the cell string 20 have basically the same configuration. Hereinafter, therefore, when no distinction is made among the electricity storage cells 11 to 14 and 21 to 24, these electricity storage cells will be referred to as “electricity storage cells 1.”

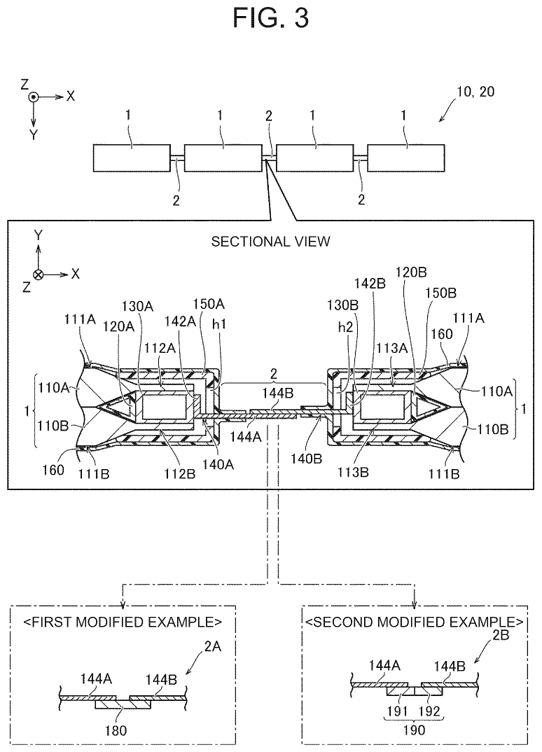

FIG. 3 is a view for describing the configuration of each of the cell strings 10 and 20. As shown in FIG. 3, each cell string includes four electricity storage cells 1. The connection parts 2 are provided between the adjacent electricity storage cells 1, and the connection parts 2 electrically connect these electricity storage cells 1 to one another. Each cell string is formed as the electricity storage cells 1 and the connection parts 2 are alternately arrayed. In each of the cell strings 10, 20, the electricity storage cells 1 are connected to one another through the connection parts 2. The rigidity of the connection part 2 is lower than the rigidity of the electricity storage cell 1. The electricity storage cells 11 to 14 and 21 to 24 are formed by the same electricity storage cells 1. Forming the cell strings 10 and 20 using the common electricity storage cells 1 eases the manufacturing of the battery 100 and can reduce the manufacturing cost.

In this embodiment, the electricity storage cell 1 is a laminate cell having one or more rolls. In the laminate cell, the one or more rolls functioning as electrode bodies are covered by a laminate exterior. The roll has, for example, a structure in which a positive electrode sheet and a negative electrode sheet are rolled with a separator interposed therebetween. Each of the positive electrode sheet and the negative electrode sheet includes an electrode foil and an active material layer.

In the following, the structures of the electricity storage cell 1 and the connection part 2 will be described using the sectional view of FIG. 3 (an X-Y sectional view around the connection part 2). The electricity storage cell 1 includes two rolls 110A, 110B, spacers 120A, 120B, terminal members 130A, 130B, and covers 150A, 150B.

The rolls 110A, 110B respectively have coated portions 111A, 111B, electrode tabs 112A, 112B, and electrode tabs 113A, 113B. Each of the coated portions 111A, 111B is a region of the electrode foil in the positive electrode sheet or the negative electrode sheet where the active material layer is provided. Each of the electrode tabs 112A, 112B, 113A, 113B is a region of the positive electrode sheet or the negative electrode sheet where the electrode foil is exposed (an uncoated portion where the active material layer is not provided). The electrode tabs 112A, 112B are located at end portions on the +X side of the rolls 110A, 110B, respectively. The electrode tabs 113A, 113B are located at end portions on the −X side of the rolls 110A, 110B, respectively.

The electrode tab 112A and the electrode tab 112B are disposed so as to overlap in the Y direction, and the spacer 120A and the terminal member 130A are provided between the electrode tab 112A and the electrode tab 112B. The electrode tab 113A and the electrode tab 113B are disposed so as to overlap in the Y direction, and the spacer 120B and the terminal member 130B are provided between the electrode tab 113A and the electrode tab 113B.

Each of the spacers 120A, 120B includes an insulation material (e.g., synthetic resin) and has insulation properties. Each of the spacers 120A, 120B has a shape of which the dimension in the Y direction becomes larger with increasing distance from the coated portions 111A, 111B. The terminal member 130A is connected to an end face on the +X side of the spacer 120A. The terminal member 130B is connected to an end face on the −X side of the spacer 120B. Each of the terminal members 130A, 130B includes an electrically conductive material (e.g., metal such as aluminum or copper) and has electrical conductivity. The roll 110A and the roll 110B are joined together (e.g., by laser welding) through the terminal members 130A and 130B.

Each of current collector terminals 140A, 140B is a component constituting a part of the connection part 2. The current collector terminals 140A, 140B respectively have support portions 142A, 142B and the protruding portions 144A, 144B. One of the current collector terminals 140A and 140B functions as a positive-electrode current collector terminal while the other one functions as a negative-electrode current collector terminal. In one example, the positive-electrode current collector terminal is made of aluminum and the negative-electrode current collector terminal is made of copper.

Each of the current collector terminals 140A, 140B is formed in an L-shape, and may be formed as two plate members that have been separately molded are joined together, or may be molded in an integral state by bending process. The support portion 142A is joined (e.g., by laser welding) to an end face on the +X side of the terminal member 130A. The support portion 142B is joined (e.g., by laser welding) to an end face on the −X side of the terminal member 130B.

The cover 150A covers an end portion on the +X side (including the electrode tabs 112A and 112B) of the electricity storage cell 1. The cover 150A is provided with a through-hole h1 for the protruding portion 144A. The protruding portion 144A passes through the through-hole h1 and protrudes to the +X side of the electricity storage cell 1. The cover 150B covers an end portion on the −X side (including the electrode tabs 113A and 113B) of the electricity storage cell 1. The cover 150B is provided with a through-hole h2 for the protruding portion 144B. The protruding portion 144B passes through the through-hole h2 and protrudes to the −X side of the electricity storage cell 1.

At the connection part 2, the protruding portion 144A protruding from one electricity storage cell 1 of the two adjacent electricity storage cells 1 is joined (e.g., by laser welding) to the protruding portion 144B protruding from the other electricity storage cell 1. This welded portion may be protected by a tape or the like. On surfaces of the two rolls 110A and 110B, a laminate exterior 160 is provided. The laminate exterior 160 is a laminate film, for example, and is provided on a surface of the electricity storage cell 1.

The above-described configuration is merely one example of the configuration of the electricity storage cell 1, and changes can be made thereto as appropriate. For example, the number of the rolls included in the electricity storage cell 1 is not limited to two, and may be one or three or more. As the electrode body, a stack (e.g., a stack in which a positive electrode sheet and a negative electrode sheet are stacked with a separator interposed therebetween) may be adopted instead of a roll.

A first modified example and a second modified example of the connection part 2 are shown at the bottom of FIG. 3.

A connection part 2A according to the first modified example further includes a metal plate 180 that is provided between the protruding portions 144A and 144B to be connected to each other. At the connection part 2A, the protruding portion 144A and the protruding portion 144B are not in contact with each other, and are electrically connected to each other through the metal plate 180. Each of the protruding portions 144A and 144B is joined (e.g., by ultrasonic joining) to the metal plate 180. Providing the metal plate 180 having high rigidity between the protruding portions 144A and 144B to be connected to each other helps perform ultrasonic joining. Ultrasonic joining is less likely to lead to formation of a brittle alloy layer.

A connection part 2B according to the second modified example further includes a clad member 190 that is provided between the protruding portions 144A and 144B to be connected to each other. At the connection part 2B, the protruding portion 144A and the protruding portion 144B are not in contact with each other, and are electrically connected to each other through the clad member 190. The clad member 190 is a dissimilar-metal joined material and includes a first metal portion 191 and a second metal portion 192. The first metal portion 191 and the second metal portion 192 are joined (e.g., by laser welding) to the protruding portions 144A, 144B, respectively. The first metal portion 191 and the second metal portion 192 may be made of the same materials as the protruding portions 144A, 144B, respectively. In one example, the protruding portion 144A on the positive electrode side made of aluminum is joined to the first metal portion 191 including aluminum, and the protruding portion 144B on the negative electrode side made of copper is joined to the second metal portion 192 including copper.

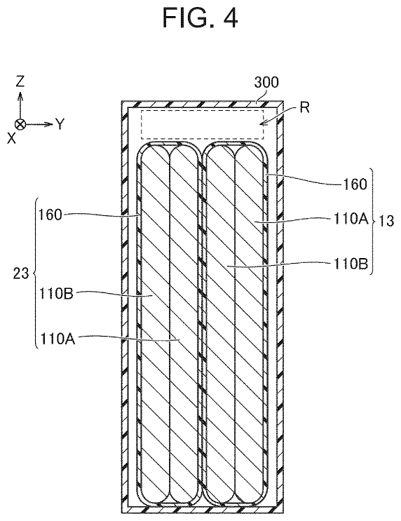

FIG. 4 is a sectional view along line IV-IV in FIG. 1. While FIG. 4 shows only the pair of electricity storage cells 13 and 23 as a representative, the other pairs of electricity storage cells opposite each other in the Y direction (the pair of electricity storage cells 11, 21, the pair of electricity storage cells 12, 22, and the pair of electricity storage cells 14, 24) have the same structure.

The case 300 is made of resin and has insulation properties. Thus, the case 300 and the components inside the case 300 are electrically insulated from each other. An unnecessary laminate film (e.g., the laminate exterior at a part where the electricity storage cells overlap) may be omitted to enhance heat dissipation. In the case 300, there is a region R as shown in FIG. 1 and FIG. 4 between a face on the +Z side of each electricity storage cell and the inner face (ceiling face) of the case. In the region R, at least one of a heat management system (e.g., a heater and/or a temperature sensor), a gas discharge system (e.g., a gas flow passage and/or a pressure sensor), a flexible printed circuit board (FPC), and a wire leading to the connector 313 may be provided. A device and/or a sensor provided in the region R may be connected to the connector 313.

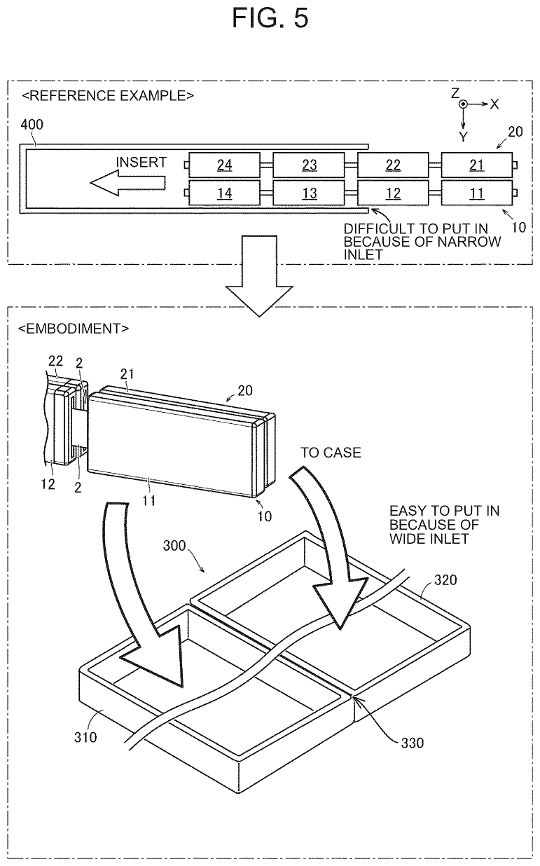

FIG. 5 is a view for describing workings and advantages produced by the battery 100. As in the reference example in FIG. 5, in a form in which the cell strings 10 and 20 electrically connected to each other are housed in a case 400 having a tubular shape closed on one side and provided with an opening in an end face on the +X side, a problem can arise that the cell strings 10 and 20 are difficult to insert into the case 400. In such a reference example, putting an inside of the case 400 in a hermetic state requires a lid member for closing the opening of the case 400. By contrast, in the battery 100 shown in FIG. 1 to FIG. 4, the hinge part 330 that opens and closes the case 300 is provided in the case 300. Thus, after the cell strings 10 and 20 are put into the case 300, with the case 300 opened by the hinge part 330, the case 300 can be closed by the hinge part 330. Such a battery 100 does not require preparing an additional lid member. Moreover, as the hinge part 330 is formed along the X direction, a large opening is likely to be formed when the case 300 is opened by the hinge part 330. That the inlet (opening) of the case 300 is wide makes it easy to put the cell strings 10 and 20 into the case 300.

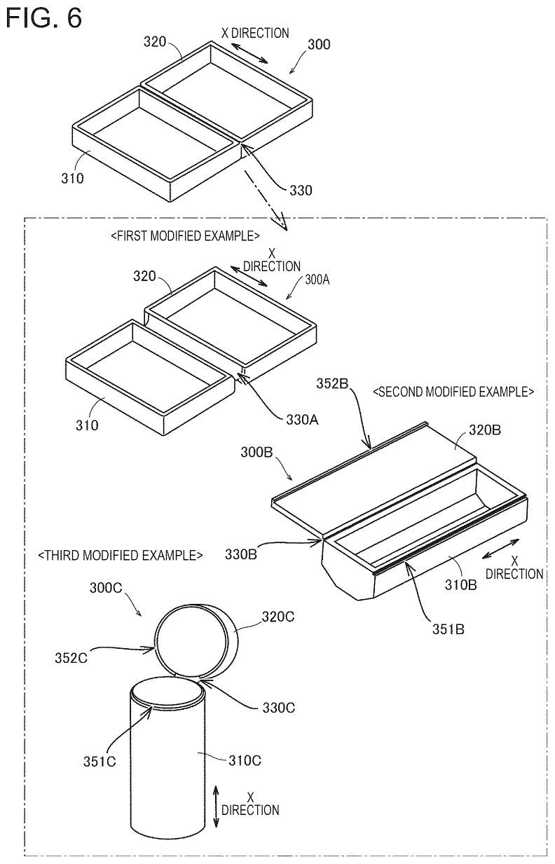

FIG. 6 is a view showing the case 300 along with first to third modified examples of the case 300.

A case 300A according to the first modified example includes, instead of the hinge part 330, a hinge part 330A that has a band shape with a larger width than the hinge part 330. Like the hinge part 330, the hinge part 330A is also formed so as to be elongated in the X direction (the coupling direction of the cell strings to be housed). However, the hinge part 330A has flexibility. In a closed state of the case 300A, the hinge part 330A bends flexibly so as to protrude toward an outer side of the case 300A.

A case 300B according to the second modified example includes, instead of the case members 310, 320 and the hinge part 330, case members 310B, 320B and a hinge part 330B. The case member 310B has a prism shape (e.g., hexagonal prism shape). The case member 310B (first case member) has a housing part (a space for housing the cell strings) and a recessed portion 351B. The case member 320B (second case member) does not have a housing part and functions as a lid member that closes an opening of the case member 310B. The case member 320B has a projecting portion 352B. Each of the case member 310B, the case member 320B, and the hinge part 330B is formed so as to be elongated in the X direction (the coupling direction of the cell strings to be housed). The recessed portion 351B and the projecting portion 352B are formed at end portions, on the opposite side from the hinge part 330B, of the case member 310B and the case member 320B, respectively. The recessed portion 351B and the projecting portion 352B are configured to be able to fit each other. As the case 300B is closed by the hinge part 330B such that the recessed portion 351B fits on the projecting portion 352B, a coupling part (a part where the case member 310B and the case member 320B are coupled to each other) is formed in a face on the opposite side from the hinge part 330B. A structure for fastening the case member 320B to the case member 310B at the coupling part may be a snap-fit structure, or may be a structure that fastens the case member 320B to the case member 310B by only a frictional force.

A case 300C according to a third modified example includes, instead of the case members 310, 320 and the hinge part 330, case members 310C, 320C and a hinge part 330C. The case member 310C (first case member) has a cylindrical shape with a longitudinal direction oriented in the X direction (the coupling direction of the cell strings to be housed). The case member 310C has a housing part (a space for housing the cell strings) and a recessed portion 351C. The case member 310C has a tubular shape closed on one side and provided with an opening at one end in the X direction. The case member 320C (second case member) does not have a housing part and functions as a lid member that closes the opening of the case member 310C. The case member 320C has a projecting portion 352C. The hinge part 330C is formed so as to be elongated in a direction orthogonal to the X direction. The case members 310C and 320C can turn around the hinge part 330C as a rotational axis. Each of the recessed portion 351C and the projecting portion 352C has a ring shape that extends from one end of the hinge part 330C and back to the other end of the hinge part 330C. The recessed portion 351C and the projecting portion 352C are configured to be able to fit each other. As the case 300C is closed by the hinge part 330C such that the recessed portion 351C fits on the projecting portion 352C, a ring-shaped coupling part (a part where the case member 310C and the case member 320C are coupled to each other) is formed. A housing part (a space for housing the cell strings) may be formed not only in the case member 310C but also in the case member 320C.

The cases (cases 300, 300A, 300B, 300C) may be made of a material other than resin. For example, the cases may be made of metal (e.g., aluminum). The first case member, the second case member, and the hinge part may be made of the same material, or may be made of different materials. The hinge part may be a hinge-like part (e.g., a flat hinge, lift-off hinge, flush hinge, pivot hinge, angle hinge, sliding hinge, flap hinge, sewing machine hinge, or continuous hinge) that is formed as a separate body from the case members.

The number of the cell strings housed in each case is not limited to two and is arbitrary. The number of the cell strings housed in the case may be three or more or may be one. The configuration of each cell string is not limited to the configuration shown in FIG. 3. Each cell string may include electricity storage cells of different dimensions, or may include electricity storage cells of different shapes. The number of the electricity storage cells included in each cell string is not limited to four, either, and can be changed as appropriate. The number of the electricity storage cells included in each cell string may be less than four, or may be five or more and 19 or less, or may be 20 or more.

The above-described battery 100 and the batteries according to the modified examples thereof can also independently function as an electricity storage device. However, a plurality of such batteries may be combined into a module. The battery 100 and the batteries according to the modified examples thereof can be installed, for example, in mobile bodies. Examples of mobile bodies include automobiles (battery electric vehicles, hybrid electric vehicles, etc.), vehicles other than automobiles (ships, airplanes, etc.), mobile machines (agricultural machines, construction machines, etc.), and unmanned mobile bodies (unmanned transport vehicles, robots, etc.). However, the purpose of the electricity storage device is arbitrary and may be a stationary purpose.

The various characteristics relating to the above-described electricity storage device (the characteristics described in the embodiment and the modified examples) may be implemented in arbitrary combinations. The electricity storage device may be applied to a device other than a vehicle.

The embodiment disclosed this time should be construed as being in every respect illustrative and not restrictive. The scope of the present disclosure is indicated not by the description of the embodiment given above but by the claims, and is intended to include all changes within the meaning and scope of the claims and equivalents thereof.

What is claimed is:

1. An electricity storage device comprising a case, wherein:
the case includes a hinge part that opens and closes the case;
the case houses a cell string; and
the cell string includes a plurality of electricity storage cells and connection parts that electrically connect the electricity storage cells to one another.

2. The electricity storage device according to claim 1, wherein:
the case has a rectangular parallelepiped shape;
the electricity storage cells are connected to one another in a first direction;
the case has a first face, a second face, a third face, and a fourth face that extend in the first direction and a fifth face and a sixth face that are located at both ends in the first direction;
the first face and the second face are opposite each other in a second direction that is orthogonal to the first direction;
the third face and the fourth face are opposite each other in a third direction that is orthogonal to each of the first direction and the second direction;
the second face includes the hinge part;
the case includes a first case member and a second case member that are connected to each other through the hinge part; and
the first face includes a coupling part where the first case member and the second case member are coupled to each other.

3. The electricity storage device according to claim 2, wherein the hinge part is a part where the second face is reduced in plate thickness, and is provided along the first direction.

4. The electricity storage device according to claim 2, wherein the coupling part has a snap-fit structure.

5. The electricity storage device according to claim 1, wherein the case is a case made of resin.
